(19) United States
(12) Patent Application Publication
(10) Pub. No.: US 2026/0113442 A1
(43) Pub. Date: Apr. 23, 2026

(54) NEURAL NETWORK (NN) BASED IN-LOOP FILTER

(71) Applicant: GUANGDONG OPPO MOBILE TELECOMMUNICATIONS CORP., LTD., Dongguan (CN)

(72) Inventors: Cheolkon JUNG, Dongguan (CN); Hao ZHANG, Dongguan (CN)

(21) Appl. No.: 19/352,866

(22) Filed: Oct. 8, 2025

Related U.S. Application Data
(63) Continuation of application No. PCT/CN2023/098379, filed on Jun. 5, 2023.

(30) Foreign Application Priority Data
Apr. 14, 2023 (WO) PCT/CN2023/088534

(51) Int. Cl. H04N 19/117; H04N 19/124; H04N 19/172; H04N 19/186; H04N 19/82

(52) U.S. Cl. CPC H04N 19/117; H04N 19/124; H04N 19/172; H04N 19/186; H04N 19/82

(57) ABSTRACT

Methods and systems for video processing are provided. The method includes that: (i) a video sequence is received by a neural network (NN) based in-loop filter, the NN based in-loop filter includes a residual transformer NN (RTNN) filter having a feature extraction module, a backbone module, and a reconstruction module; (ii) features are extracted by the feature extraction module from input information, the input information includes a quantization parameter (QP) map, a reconstruction picture, a prediction picture and a partition picture; (iii) a feature map is generated by the backbone module based an output from the feature extraction module, the backbone module includes multiple residual blocks and a transformer block (TB); and (iv) a dimension-reduced feature map is generated by the reconstruction module based on the feature map via a convolution process.

### CROSS-REFERENCE TO RELATED APPLICATIONS

This is a continuation application of International Patent Application No. PCT/CN2023/098379, filed on Jun. 5, 2023, which is based on and claims priority to International Patent Application No. PCT/CN2023/088534, filed on Apr. 14, 2023, both of which are hereby incorporated by reference in their entirety.

### BACKGROUND

Existing video compression methods, such as High Efficiency Video Coding (HEVC) and Versatile Video Coding (VVC) perform blocking and quantization processes when encoding. These processes result in irreversible information loss and various compression artifacts, such as blocking, blurring, and banding artifacts. The foregoing issue is especially significant especially when compression ratios are high. Although there are certain methods trying to reduce these compression artifacts, they are not efficient and require significant computing resources. Therefore, it is advantageous to have an improved system and method to address the foregoing needs.

### SUMMARY

The present disclosure relates to imaging and display technologies. More particularly, video compression schemes including a neural network (NN) based in-loop filter are disclosed herein.

The technical solutions of the embodiments of the present disclosure can be implemented as follows.

In a first aspect, there is provided a method for video encoding, including that: a video sequence is received by a neural network (NN) based in-loop filter, herein the NN based in-loop filter includes a residual transformer NN (RTNN) filter having a feature extraction module, a backbone module, and a reconstruction module; features are extracted by the feature extraction module from input information, herein the input information includes a quantization parameter (QP) map and a reconstruction picture; a feature map is generated by the backbone module based an output from the feature extraction module, herein the backbone module includes multiple residual blocks and a transformer block (TB); and a dimension-reduced feature map is generated by the reconstruction module based on the feature map via a convolution process.

In a second aspect, there is provided a method for video decoding, including that: a video sequence is received by a neural network (NN) based in-loop filter, herein the NN based in-loop filter includes a residual transformer NN (RTNN) filter having a feature extraction module, a backbone module, and a reconstruction module; features are extracted by the feature extraction module from input information, herein the input information includes a quantization parameter (QP) map and a reconstruction picture; a feature map is generated by the backbone module based an output from the feature extraction module, herein the backbone module includes multiple residual blocks and a transformer block (TB); and a dimension-reduced feature map is generated by the reconstruction module based on the feature map via a convolution process.

In a third aspect, there is provided a system for video decoding, including a processor; and a memory configured to store instructions. The instructions are executed by the processor to: receive a video sequence by a neural network (NN) based in-loop filter, wherein the NN based in-loop filter includes a residual transformer NN (RTNN) filter having a feature extraction module, a backbone module, and a reconstruction module; extract, by the feature extraction module, features from input information, wherein the input information includes a quantization parameter (QP) map, a reconstruction picture, a prediction picture, and a partition picture; generate, by the backbone module, a feature map based an output from the feature extraction module, wherein the backbone module includes multiple residual blocks and a transformer block (TB); and generate, by the reconstruction module, a dimension-reduced feature map based on the feature map via a convolution process.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram illustrating a system (in VVC structure) having an RTNN filter (or NN-based in-loop filter) in accordance with one or more implementations of the present disclosure.

FIG. 2 is a schematic diagram illustrating an RTNN filter in accordance with one or more implementations of the present disclosure.

FIG. 3 is a schematic diagram illustrating processes of the RTNN filter in accordance with one or more implementations of the present disclosure.

FIG. 4A and FIG. 4B are schematic diagrams illustrating network architectures of a reconstruction part in accordance with one or more implementations of the present disclosure. FIG. 4A shows a network architecture for a luma model, and FIG. 4B shows a network architecture for a chroma model.

FIG. 5A and FIG. 5B are schematic diagrams illustrating network architectures of a feature extraction part in accordance with one or more implementations of the present disclosure. FIG. 5A shows a network architecture for a luma model (I-slice or I-frame; intra-coded), and FIG. 5B shows a network architecture for a chroma model (I-slice or I-frame; intra-coded).

FIG. 6A to FIG. 6C are schematic diagrams illustrating network architectures of a backbone part for luma components in accordance with one or more implementations of the present disclosure. FIG. 6A shows a residual block (ResBlock), FIG. 6B shows a residual block groups (RBG), and FIG. 6C shows a backbone of a luma model.

FIG. 7A to FIG. 7C are schematic diagrams illustrating network architectures of the backbone part for chroma components in accordance with one or more implementations of the present disclosure. FIG. 7A shows a residual block (ResBlock), FIG. 7B shows a residual attention block (RAB), and FIG. 7C shows a backbone of a chroma model.

FIG. 8A to FIG. 8C are schematic diagrams illustrating network architectures of attention blocks for chroma components in accordance with one or more implementations of the present disclosure. FIG. 8A shows a spatial attention (SA) block, FIG. 8B shows a channel attention (CA) block, and FIG. 8C shows a final attention block in the RAB.

FIG. 9A is a schematic diagram illustrating an intensity channel attention module of a channel attention block (FIG. 8B).

FIG. 9B is a schematic diagram illustrating a contrast channel attention module of a channel attention block (FIG. 8B).

FIG. 10 is a schematic diagram illustrating a process of acquiring a dataset.

FIG. 11A and FIG. 11B are schematic diagrams illustrating training strategies in accordance with the present disclosure. FIG. 11A shows a single stage training strategy for in-loop filters, and FIG. 11B shows a multi-stage training strategy for in-loop filters.

FIG. 12 is a schematic diagram illustrating an iterative training strategy in accordance with one or more implementations of the present disclosure.

FIG. 13 is a schematic diagram of a wireless communication system in accordance with one or more implementations of the present disclosure.

FIG. 14 is a schematic block diagram of a terminal device in accordance with one or more implementations of the present disclosure.

FIG. 15 is a schematic block diagram of an electronic device in accordance with one or more implementations of the present disclosure.

FIG. 16 is a flowchart of a method in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

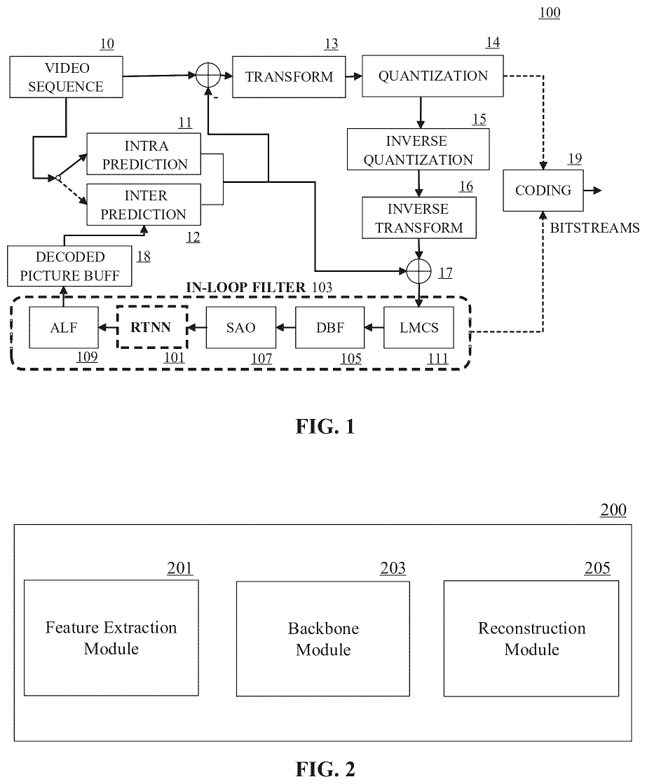

FIG. 1 is a schematic diagram illustrating a system 100 (in a VVC structure) having an RTNN filter 101 (in an in-loop filter 103) in accordance with one or more implementations of the present disclosure. The system 100 is configured in accordance with the VVC structure.

The system 100 includes a video sequence 10 as input to an intra prediction module 11 and/or an inter prediction module 12. The output of the intra prediction module 11 and the inter prediction module 12 can be directed to a transform module 13. The output of the transform module 13 can be quantized by a quantization module 14. The output of the quantization module 14 can then be directed to an inverse quantization module 15 and an inverse transform module 16. Generally speaking, with an increase of Quantization Parameter (QP), compression artifacts become more and more significant/serious (i.e., image qualities get worse).

As shown in FIG. 1, at an adder 17, the output of the intra prediction module 11 and the inter prediction module 12 can be added with the output of the inverse transform module 16. The added result can then be directed to the in-loop filter 103. The output of the in-loop filter 103 can then be directed to a decoded picture buffer 18 for further processes by the inter prediction module 12.

The system 100 uses loop filters to suppress compression artifacts and reduce distortion. These loop filters includes a deblocking filter (DBF) 105, a sample adaptive offset (SAO) filter 107, and an adaptive loop filter (ALF) 109. As shown in FIG. 1, the RTNN filter 101 can be positioned between the SAO filter 107 and the ALF 109.

In some embodiments, the DBF 105 and the SAO filter 107 are two filters designed to reduce artifacts caused by an encoding process. The DBF 105 focuses on visual artifacts at block boundaries. The SAO filter 107 complementarily reduces artifacts that may arise from quantization of transform coefficients within blocks. The ALF 109 can enhance an adaptive filter of a reconstructed signal, reducing a mean square error (MSE) between the original and reconstructed samples by using a Wiener-based adaptive filter. As shown, the in-loop filter 103 can also include an LMCS (luma mapping with chroma scaling) filter 111. The LMCS filter 111 is configured to (1) map input luma code values to a new set of code values for use inside a coding loop; and 2) scale chroma residue values according to the luma code values.

The present disclosure is related to systems and methods for improving image qualities of videos using a neural network for video compression. More particularly, the present disclosure provides a neural network (NN) based in-loop filter to enhance image qualities. Though the following systems and methods are described in relation to video processing, in some embodiments, the systems and methods may be used for other image processing systems and methods. The present disclosure also provides a framework that can be trained by deep learning and/or artificial intelligent schemes.

The NN based in-loop filter in the present disclosure is based on residual blocks (ResBlock) and transformer blocks (TB). The NN based in-loop filter in the present disclosure can be called as an RTNN (Residual Transformer Neural Network) filter. The RTNN filter can achieve a good performance with an acceptable computational complexity, therefore resulting in a good balance/trade-off between complexity and performance.

The present methods and systems also introduce auxiliary information such as partition information and quantization parameter (QP) map into an attention module of the RTNN filter so as to achieve effective feature refinement. In addition, multi-stage progressive training and iterative training can also be used to increase/maximize learning ability of the proposed network.

FIG. 2 is a schematic diagram illustrating an RTNN filter 200 in accordance with one or more implementations of the present disclosure. As shown, the RTNN filter 200 includes a feature extraction module 201, a backbone module 203, and a reconstruction module 205. In some embodiments, one or more of these modules can be designed according to various components (such as luma components and/or chroma components) as well as picture frames (e.g., I-Slice, B slice, etc.). For example, the RTNN filter 200 can be suitable for at least four type of models (for different types of inputs): (1) a luma model for I-Slice, (2) a chroma model for I-Slice, (3) a luma model for B-Slice, and (4) a chroma model for B-Slice.

The feature extraction module 201 is configured to extra features from a video sequence. More particularly, the feature extraction module 201 performs a convolution process and a parametric rectified linear unit (PReLU) process for each set of input information from the video sequence. The feature extraction module 201 then concatenates the processed data and then performs further convolution and PReLU processes such that the data can be further processed by the backbone module 203.

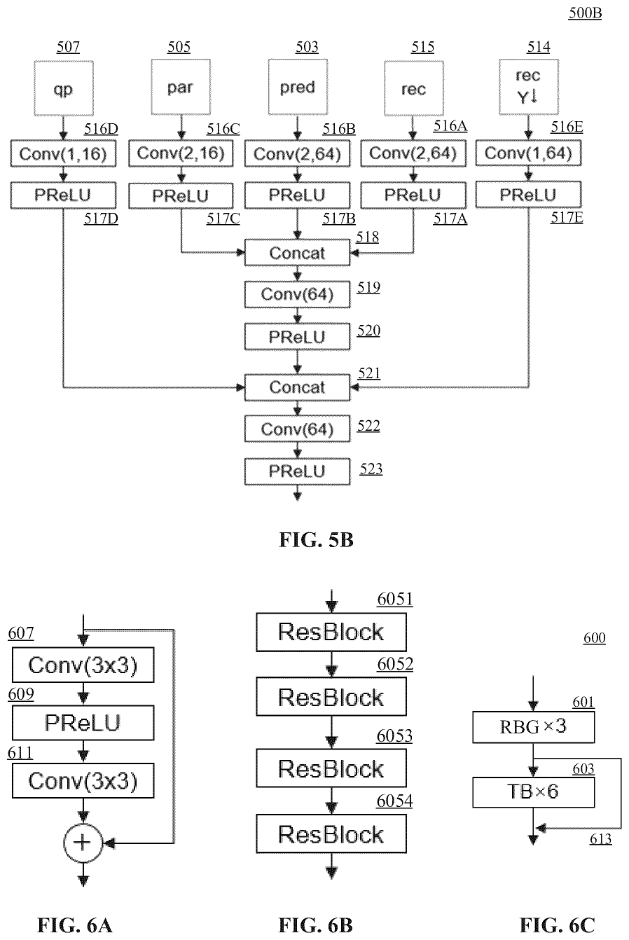

In some embodiments, for a luma model, input information of the feature extraction module 201 can include: (1) a reconstruction frame/picture, (2) a prediction frame/picture, (3) a partition frame/picture, and (4) a quantization parameter (QP) map. Related embodiments are discussed in detail with reference to FIG. 5A.

In some embodiments, for a chroma model, input information of the feature extraction module 201 can include: (1) a reconstruction frame/picture, (2) a prediction frame/picture, (3) a partition frame/picture, (4) a QP map, and (5) a reconstructed frame/picture of a luma component (e.g., the luma component corresponding to the chroma component in process, for example, in the same frame/picture). Related embodiments are discussed in detail with reference to FIG. 5B.

In some embodiments, the methods discussed herein for a “picture” or a “frame” can be applied to a portion or a region of the “picture” or the “frame.” For example, the methods disclosed herein can be applied to a sub-picture, a region of a picture (e.g., showing an object of interest), etc.

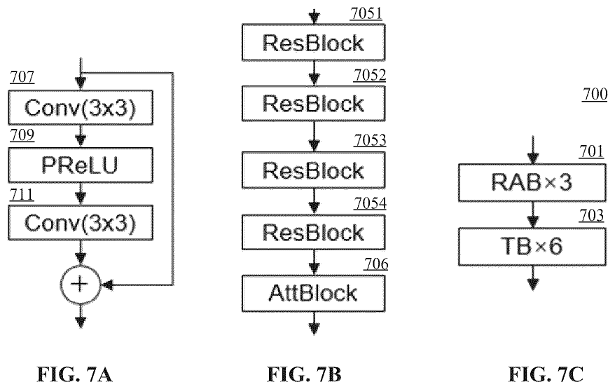

The backbone module 203 is configured to receive an output of the feature extraction module 201, and to feed a feature map to the reconstruction module 205. In the backbone module 203, residual blocks (ResBlocks) and a transformer block (TB) are combined to extract and process intermediate features. For example, the residual blocks are configured to extract shallow features of the input and capture correlation between local features. The transformer block can be used to capture a long-range correlation between features. Related embodiments are discussed in detail with reference to FIG. 6A to FIG. 6C (for luma models) and FIG. 7A to FIG. 7C (for chroma models).

The reconstruction module 205 is configured to take the feature map from the backbone module 203 as an input, and use a “lxi” convolution layer to reduce the channel dimension of the feature map so as to obtain dimension-reduced features. For a luma model, a pixel shuffle (PS) operation can be used to up-sample the dimension-reduced features to obtain a three-channel residual map. The obtained residual map can be added to the reconstruction frame/picture of the input information, thereby enhancing image quality of the reconstruction frame/picture.

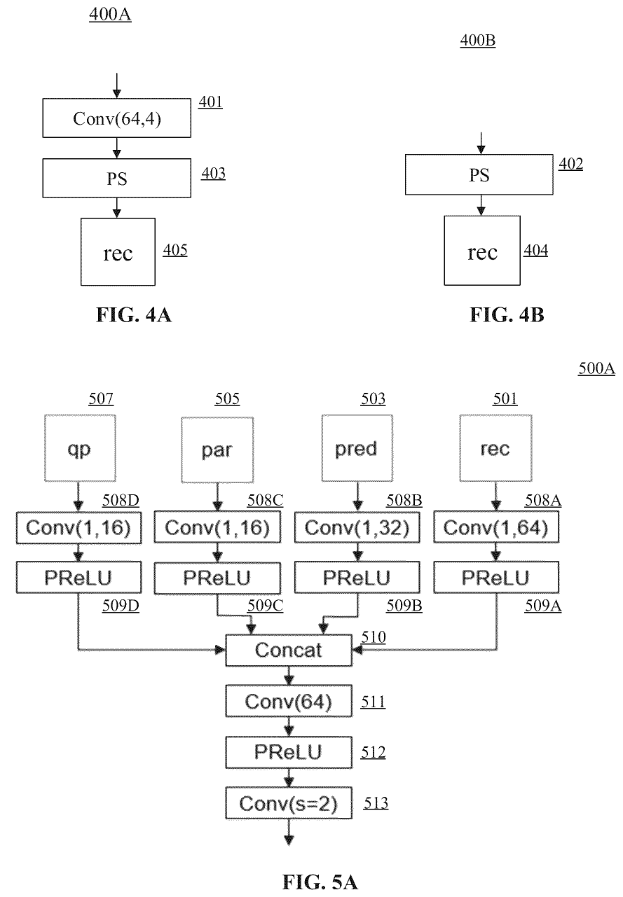

In some embodiments, for a luma model, the reconstruction module 205 can be further configured to up-sample the dimension-reduced features to obtain a three-channel residual map. The obtained residual map can be added to obtain a reconstruction frame/picture. Related embodiments are discussed in detail with reference to FIG. 4A (luma) and FIG. 4B (chroma).

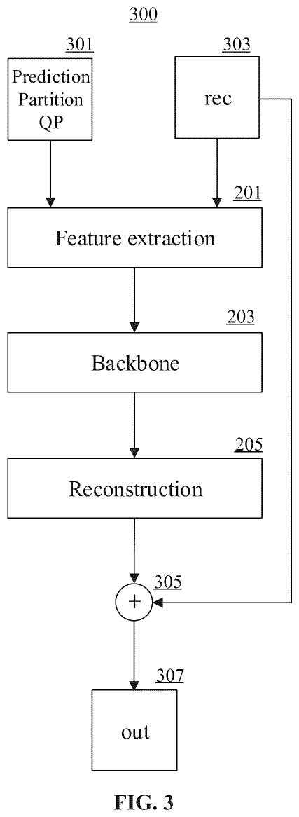

FIG. 3 is a schematic diagram illustrating a process 300 of the RTNN filter 200 in accordance with one or more implementations of the present disclosure. As shown in FIG. 3, the feature extraction module 201 can receive input information 301, which further includes a prediction frame/picture, a partition frame/picture, and a QP map. The feature extraction module 201 can also receive a reconstruction frame/picture 303 as input.

In some embodiments, the prediction frame/picture can include prediction information of a current frame/picture and can be generated by a neighboring frame/picture. In some implementations, the partition frame/picture can include block information of the current frame/picture. The QP map can represent quantization information used by the current frame/picture.

In the backbone module 203, luma models and chroma models are processed differently with residual blocks and transformer blocks. For a luma model, the residual blocks can be called as residual block groups (RBGs). Embodiments of the RBGs are discussed in detail in FIG. 6B and FIG. 6C.

For a chroma model, the residual blocks can have an “attention” block (e.g., paying specific attention to certain features, etc.) and thus can be called as residual attention blocks (RABs). Embodiments of the RABs are discussed in detail in FIG. 7B and FIG. 7C.

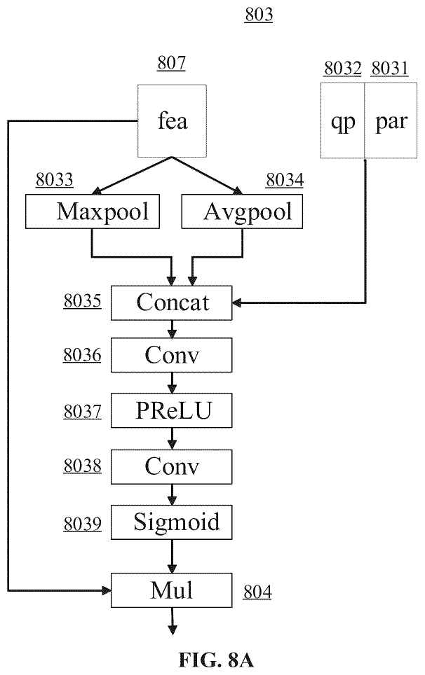

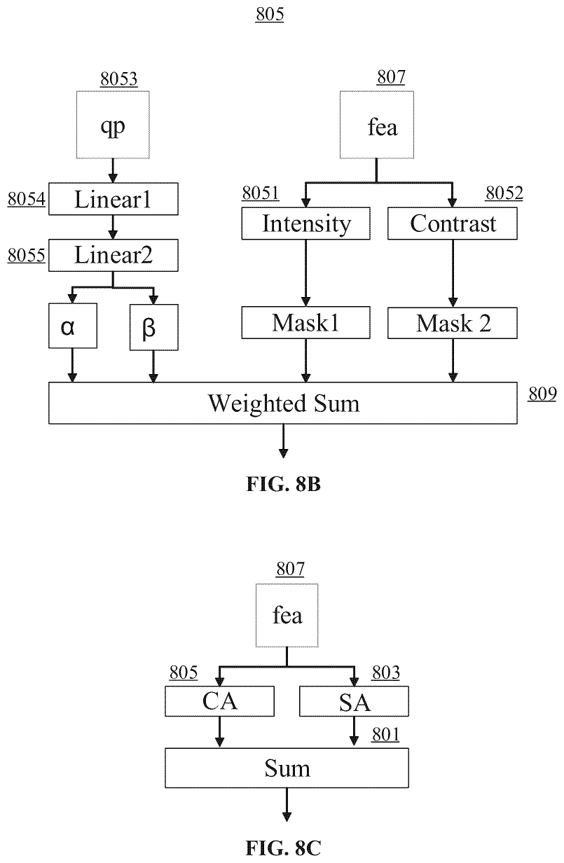

In some embodiments, the attention block can include a spatial attention (SA) module (e.g., focusing on spatial relationship) and a channel attention (CA) module (e.g., focusing on channels). For example, inputs of the spatial attention module can include the partition frame/picture, the QP map, a max-pooling map, and an average-pooling map. In the spatial attention module, the inputs can be first combined into a group of inputs through concatenate operations. Then some features can be extracted through two convolution operations so as to obtain a spatial attention map through a sigmoid activation function. Embodiments of the SA module are discussed in detail in FIG. 8A.

The channel attention (CA) block can include an intensity channel attention module and a contrast channel attention module. In some embodiments, the intensity channel attention module can be configured to extract a weight of each channel through global average pooling, channel compression, and expansion processes. Then the extracted weight can be multiplied by the feature map so as to obtain a channel attention map. Embodiments of the CA module are discussed in detail in FIG. 8B. The result of the CA module and the SA module can then be combined (see e.g., FIG. 8C) and outputted to the reconstruction module 205.

The reconstruction module 205 can then combine the output from the backbone module 203 and the (input) reconstruction frame/picture 303 so as to generate an output 307 for further processes (e.g., to the ALF 109 shown in FIG. 1).

FIG. 4A and FIG. 4B are schematic diagrams illustrating network architectures of a reconstruction part in accordance with one or more implementations of the present disclosure. FIG. 4A shows a network architecture for a luma model 400A, and FIG. 4B shows a network architecture for a chroma model 400B.

In FIG. 4A, a reconstruction process for the luma model 400A includes a convolution layer 401 (with 64 input channels and 4 output channels) and a pixel shuffle layer 403 so as to form a reconstruction frame/picture 405. In FIG. 4B, a reconstruction process for the chroma model 400B includes a convolution layer 402 (with 64 input channels and 2 output channels) to form a reconstruction frame/picture 404

FIG. 5A and FIG. 5B are schematic diagrams illustrating network architectures of a feature extraction part in accordance with one or more implementations of the present disclosure. FIG. 5A shows a network architecture for a luma model 500A (I-slice or I-frame; intra-coded).

As illustrated in FIG. 5A, for the luma model 500A, input information can include a (luma) reconstruction frame 501, a prediction frame 503, a partition frame 505, and a QP map 507. The input information is first convolved to extract shallow features by convolution layers with different numbers of input and output channels. More particularly, a convolution layer 508A is for the reconstruction frame 501 and has 1 input channel and 64 output channels. Similarly, a convolution layer 508B is for the prediction frame 503 and has 1 input channel and 32 output channels. A convolution layer 508C is for the partition frame 505 and has 1 input channel and 16 output channels. A convolution layer 508D is for the QP map 507 and also has 1 input channel and 16 output channels. The process then uses PReLU layers 509A-D to further process the output of the convolution layers 508A-D, respectively. The concatenation layer 510 then fuses the outputs from the PReLU layers 509A-D. Further convolution process is performed by a convolution layer 511 (with 64 input/output channels). A PReLU layer 512 further rectifies the data and then sends it to a convolution layer 513. The convolution layer 513 can down-sample the fused features by convolution with a step size of 2 (i.e., stride=2) so as to save computing resources. The results are to be used as input of the backbone part/module.

FIG. 5B shows a network architecture for a chroma model 500B (I-slice or I-frame; intra-coded). As shown in FIG. 5B, in addition to the foregoing input information (a chroma reconstruction frame 515, the prediction frame 503, the partition frame 505, and the QP map 507), a luma reconstructed frame 514 of the luma component is also used as an additional input. Since the luma component contains more information, it can be used to provide more accurate structure and texture information for the chroma model, so as to better improve the quality of the chroma component.

Due to the different types of input information, a progressive fusion method is used to obtain more accurate fusion features. Specifically, the chroma reconstruction frame 515, the prediction frame 503, and the partition frame 505 are fused first to obtain chroma-related fusion features (i.e., by convolution layers 516A-E, PReLU layers 517A-E, concatenation layer 518, convolution layer 519, and PReLU layer 520 as shown). After that, the luma reconstruction frame 514, the chroma fusion feature, and the QP map 507 are fused through concatenation layer 521 and convolution layer 522 and PReLU layer 523 to obtain the final fusion features.

FIG. 6A to FIG. 6C are schematic diagrams illustrating network architectures of a backbone part for luma components in accordance with one or more implementations of the present disclosure. FIG. 6C shows a backbone of a luma model 600. The luma model 600 includes three residual block groups (RBGs) 601 and six transformer blocks (TB) 603. The TB 603 is configured to capture a long-range correlation between features, thereby facilitating the present network to acquire more effective residual features.

As shown in FIG. 6B, each of the RBGs 601 includes four residual blocks 605 (shown as 6051, 6052, 6053, and 6054 in FIG. 6B). As shown in FIG. 6A, each of the residual blocks 605 includes a “3×3” convolution layer 607, a PReLU layer 609, and a “3×3” convolution layer 611.

The luma (Y) component can contain rich structural information with very rich details. For neural networks, as the depth increases, the structural information in the feature map would gradually dominate. If learned deep features are directly used, it would be difficult for the restoration of details. Due to the fact that shallow features contain more detailed information, these features are also crucial for the recovery of the luma (Y) component. As a result, a residual connection 613 (FIG. 6C) has been added to the luma-backbone for interaction between shallow and deep features so as to restore higher quality luma frames.

FIG. 7A to FIG. 7C are schematic diagrams illustrating network architectures of a backbone part for chroma components in accordance with one or more implementations of the present disclosure. FIG. 7C shows a backbone of a chroma model 700. The chroma model 700 includes three residual attention blocks (RABs) 701 and six transformer blocks (TB) 703. The TB 703 is configured to capture a long-range correlation between features, thereby facilitating the present network to acquire more effective residual features.

As shown in FIG. 7B, each of the RABs 701 includes four residual blocks 705 (shown as 7051, 7052, 7053, and 7054 in FIG. 7B) and an attention block 706. As shown in FIG. 7A, each of the residual blocks 705 includes a “3×3” convolution layer 707, a PReLU layer 709, and a “3×3” convolution layer 711.

FIG. 8A to FIG. 8C are schematic diagrams illustrating network architectures of attention blocks for chroma components in accordance with one or more implementations of the present disclosure. The attention blocks can include two types: a spatial attention (SA) block and a channel attention (CA) block.

FIG. 8C provides an overall of a final attention block 801, which combines results from a SA block 803 and a CA block 805. The SA block 803 and the CA block 805 are configured to extract specific features from a current feature map 807.

FIG. 8A shows an example of the SA block 803. As shown, in the SA block 503, input information mainly includes a partition frame 8031, a QP map 8032, a max-pooling map 8033, and an average-pooling map 8034. The partition frame 8031 and the QP map 8032 are introduced to better locate the regions where the blocking effect and distortion are located spatially. The max-pooling map 8033 and the average-pooling map 8034 are used to merge and acquire important spatial features in the current feature map 807.

The foregoing inputs (e.g., the partition frame 8031, the QP map 8032, the max-pooling map 8033 and the average-pooling map 8034) are first combined into a group of inputs through a concatenate operation (by a concatenate layer 8035). Then features are extracted through two convolution operations (by convolution layers 8036, 8038 and a PReLu layer 8037). The spatial attention map is obtained through a sigmoid activation function 8039. The attention map is finally used to emphasize important spatial features by a pointwise multiplication 804.

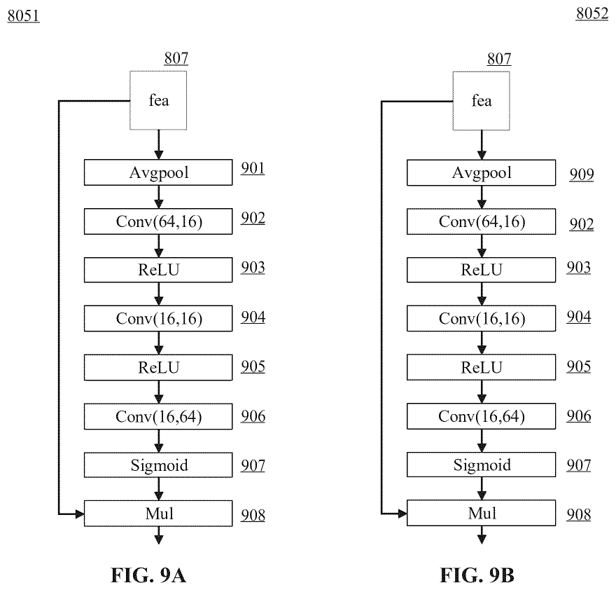

FIG. 8B shows an example of the CA block 805. The CA block 805 includes two key components, an intensity channel attention module 8051 and a contrast channel attention module 8052. Details of the intensity channel attention module 8051 are shown in FIG. 9A. Details of the contrast channel attention module 8052 are shown in FIG. 9B.

The intensity channel attention module 8051 extracts the weight of each channels through a global average pooling (8034 in FIG. 8A), a channel compression process and an expansion process. Then, the extracted weight can be multiplied by the input feature map 807 (e.g., via “Mask 1” and “Mask 2” in FIG. 8B) to obtain a channel attention map 809.

Compared with the intensity channel attention module 8051, the main difference of the contrast channel attention module 8052 is that the input is the sum of the mean and variance of the feature map 807, rather than the result of the global average pooling. The calculation process of the mean and variance can be shown in Equation (A) below.

$$mean = \frac{1}{H \times W} {\sum }_{i , j ∈ H , W} {F}_{i , j} \qquad Equation ( A )$$

$$var = \sqrt{\frac{1}{H \times W} {\sum }_{i , j ∈ H , W} {( {F}_{i , j} - mean )}^{2}}$$

In Equation (A), “H” represents a height of a block and “W” represents a width of the block. “F” represents a feature function for calculation.

In some embodiments, although the average pooling can indeed improve the peak signal to noise ratio (PSNR) value, it lacks the information about structures, textures, and edges that are propitious to enhance image details (related to structural similarity index (SSIM)). Therefore, the contrast channel attention module 8052 can replace the global average pooling summation of a standard deviation and mean (i.e., the contrast of an evaluation feature map) to complement the intensity channel attention module 8052.

Besides, a QP map 8032 can also be introduced to fuse the results of the intensity attention module 8051 and the contrast attention module 8052. This is mainly due to an observation that the network tends to focus on structural features for larger QP inputs, while the network tends to focus on texture features for smaller QP inputs. The QP map 8032 can be process by two liner layers 8054, 8055 (i.e., performing a squeeze and excitation process). For example, the linear layer 8054 can have 64 input channels and 16 output channels. The linear layer 8055 can have 16 input channels and 64 output channels. Parameters “a” and “3” can then be used as weighting parameters for the intensity channel attention module 8051 and the contrast channel attention module 8052.

In some embodiments, a squeeze and excitation (SE) process can be described as follows.

Squeeze: First, a global average pooling on an input feature map is performed to obtain squeezed features (f_{sq}). Each of the learned filters operates with a local receptive field and consequently each unit of the transformation output is unable to exploit contextual information outside of this region. To mitigate this problem, the SE attention mechanism first “squeezes” global spatial information into a channel descriptor. This is achieved by a global average pooling to generate channel-wise statistics.

Excitation: This step is motivated to better obtain the dependency of each channel. Two conditions need to be met: the first condition is that the nonlinear relationship between each channel can be learned, and the second condition is that each channel has an output (e.g., the value cannot be 0). An activation function in the illustrated embodiments can be “sigmoid” instead of the commonly used ReLU. The excitation process is that f_{sq} passes through two fully connected layers to compress and restore the channel. In image processing, to avoid the conversion between matrices and vectors, 1×1 convolution layer is used instead of using a fully connected layer.

FIG. 9A is a schematic diagram illustrating an example of the intensity channel attention module 8051 (FIG. 8B). As shown, the intensity channel attention module 8051 includes an average pooling layer 901, a convolution layer 902 (with 64 input channels and 16 output channels), a ReLu layer 903, a convolution layer 904 (with 16 input channels and 16 output channels), a ReLu layer 905, a convolution layer 906 (with 16 input channels and 64 output channels), a sigmoid activation function layer 907, and a multiplication layer 908.

FIG. 9B is a schematic diagram illustrating an example of the contrast channel attention module 8052 (FIG. 8B). As shown, the contrast channel attention module 8052 includes a contrast layer 909, the convolution layer 902 (with 64 input channels and 16 output channels), the ReLu layer 903, the convolution layer 904 (with 16 input channels and 16 output channels), the ReLu layer 905, the convolution layer 906 (with 16 input channels and 64 output channels), the sigmoid activation function layer 907, and the multiplication layer 908.

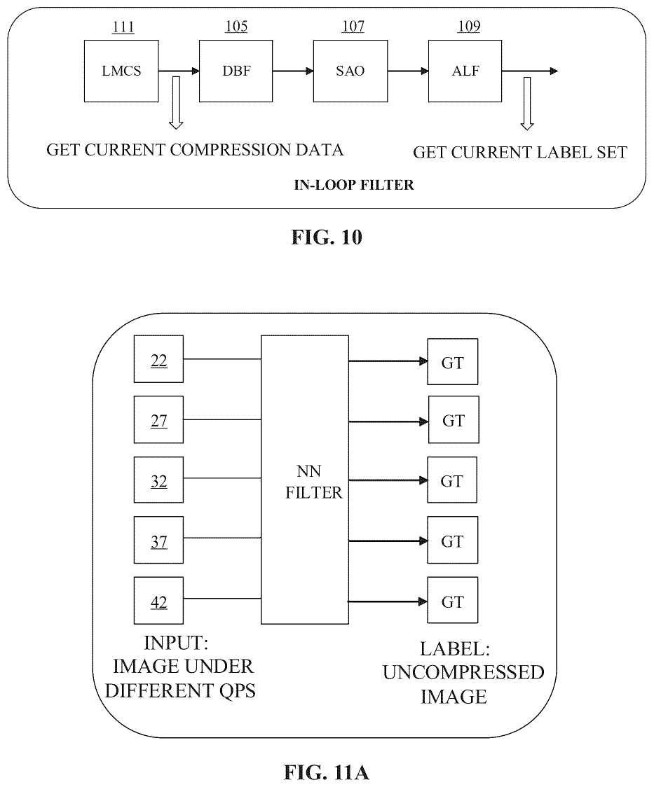

FIG. 10 is a schematic diagram illustrating a process of acquiring a dataset in an in-loop filter. As shown in FIG. 10, current compression data can be retrieved between the LMCS module 111 and the DBF module 105, and a current label set (e.g., to be used as benchmarks, references, ground truth GT, etc.) can be retrieved after the ALF module. By this arrangement, the retrieved current compression data and the current label set can be used to train the RTNN filter discussed herein.

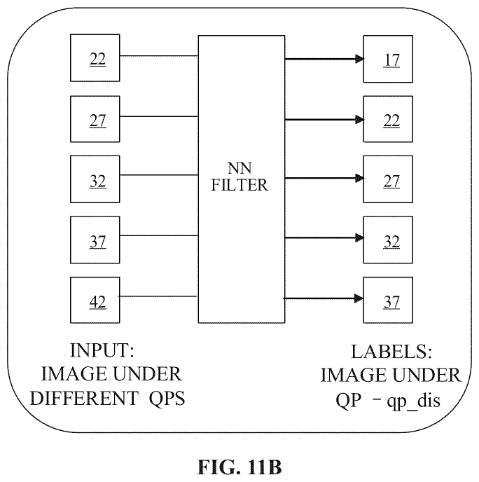

FIG. 11A to FIG. 11B are schematic diagrams illustrating training strategies in accordance with the present disclosure. FIG. 11A shows a single stage training strategy for in-loop filters, and FIG. 11B shows a multi-stage training strategy for in-loop filters. In FIG. 11A, training is less efficient because it takes more time and computing resources to train images under different QPs to the same ground truth GT. In FIG. 11B, it is more efficiency to train images under different QPs to different labels (annotated as “QP-qp_dis”) according to QP “distances” (i.e., the difference between two QP numbers).

In some embodiments, loss functions can be used to train the RTNN filter discussed herein. For example, L1 loss and L2 loss can be used to train the RTNN filter. The loss function for luma and chroma model can be expressed as follows:

$${L}_{luma} = Loss ( {rec}_{Y} - {label}_{Y} ) \qquad Equation ( B )$$

$${L}_{chroma} = Loss ( {rec}_{U} - {label}_{U} ) + Loss ( {rec}_{V} - {label}_{V} )$$

“Loss” indicates “L1 loss” or “L2 loss” function. In some embodiments, L1 loss can used in the first and mid-training period, and “L2 loss” can be used in the late training period.

Parameter “qp_dis” represents the QP difference between the network input and the label. Since the smaller QP represents a higher quality, the QP value of the label is lower than that of the input. First, smaller “qp_dis” can be used to train the network until convergence. Then, “qp_dis” can be gradually increased to train the network. Since the loss function can be a “multi-stage” loss, the loss function can be combined with the training strategy.

In some embodiments, for example, a trainer can set “qp_dis=5” and train the network with L1 and L2 loss functions successively. Then, “qp_dis” is increased by 10, and then train the network again with L1 and L2 loss functions. After that, “qp_dis” can be further increased and repeat the training processes.

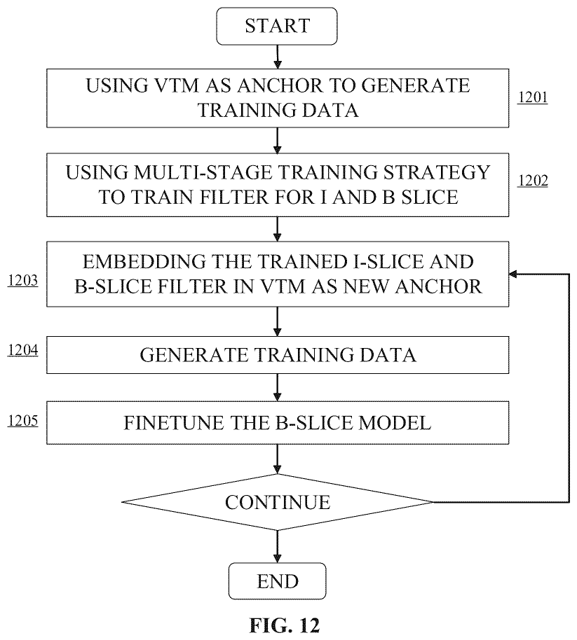

FIG. 12 is a schematic diagram illustrating an iterative training strategy in accordance with one or more implementations of the present disclosure. An iterative training strategy is used to use VTM (VVC Test Model) as anchor to generate training data (Step 1201) and then train the model for processing B-Slice.

The four proposed filters (I-luma; I-chroma; B-luma; B-chroma) are initially trained using a multi-stage progressive training strategy (Step 1202). Then the parameters of these filters can be fixed and embedded in VTM (Step 1203) to generate new training data (Step 1204) Finally, the training data obtained are used to finetune B-Luma and B-Chroma to further improve performance (Step 1205). It should be noted that in the fine-tuning stage, the multi-stage progressive training strategy can still be used.

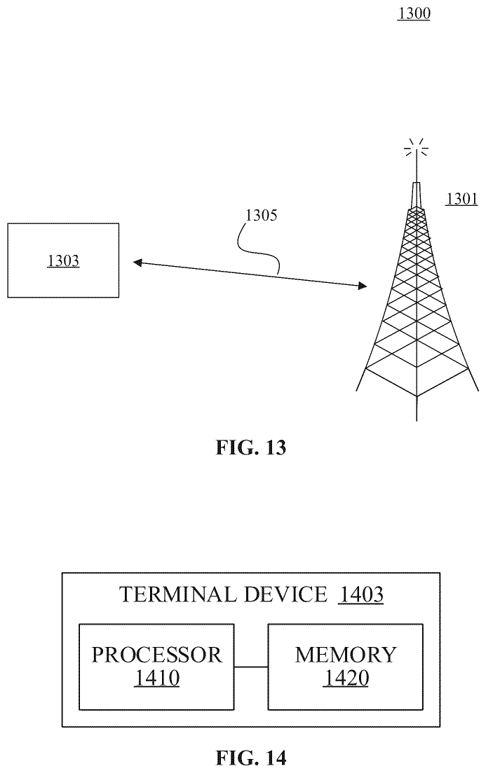

FIG. 13 is a schematic diagram of a wireless communication system 1300 in accordance with one or more implementations of the present disclosure. The wireless communication system 1300 can implement the framework discussed herein. As shown in FIG. 13, the wireless communications system 1300 can include a network device (or base station) 1301. Examples of the network device 1301 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 1301 can include a relay station, an access point, an in-vehicle device, a wearable device, and the like. The network device 1301 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 13, the wireless communications system 1300 also includes a terminal device 1303. The terminal device 1303 can be an end-user device configured to facilitate wireless communication. The terminal device 1303 can be configured to wirelessly connect to the network device 1301 (via, e.g., via a wireless channel 1305) according to one or more corresponding communication protocols/standards. The terminal device 1303 may be mobile or fixed. The terminal device 1303 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 1303 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 13 illustrates only one network device 1301 and one terminal device 1303 in the wireless communications system 1300. However, in some instances, the wireless communications system 1300 can include additional network device 1301 and/or terminal device 1303.

FIG. 14 is a schematic block diagram of a terminal device 1403 (e.g., which can implement the methods discussed herein) in accordance with one or more implementations of the present disclosure. As shown, the terminal device 1403 includes a processor 1410 (e.g., a DSP, a CPU, a GPU, etc.) and a memory 1420. The processor 1410 can be configured to implement instructions that correspond to the methods discussed herein and/or other aspects of the implementations described above. It should be understood that the processor 1410 in the implementations of this technology may be an integrated circuit chip and has a signal processing capability. During implementation, the steps in the foregoing method may be implemented by using an integrated logic circuit of hardware in the processor 1410 or an instruction in the form of software. The processor 1410 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 1410 may be a microprocessor, or the processor 1410 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 1420, and the processor 1410 reads information in the memory 1420 and completes the steps in the foregoing methods in combination with the hardware thereof.

It may be understood that the memory 1420 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

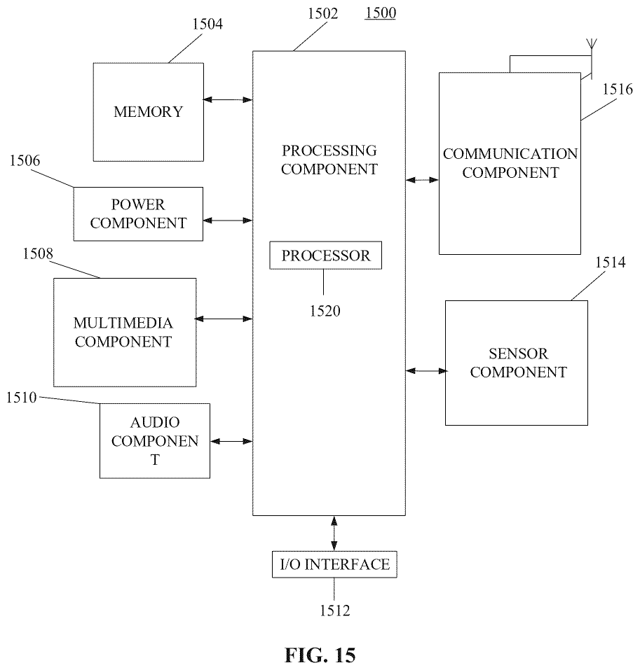

FIG. 15 is a schematic block diagram of an electronic device 1500 in accordance with one or more implementations of the present disclosure. The electronic device 1500 may include one or more following components: a processing component 1502, a memory 1504, a power component 1506, a multimedia component 1508, an audio component 1510, an Input/Output (I/O) interface 1512, a sensor component 1514, and a communication component 1516.

The processing component 1502 typically controls overall operations of the electronic device, such as the operations associated with display, telephone calls, data communications, camera operations, and recording operations. The processing component 1502 may include one or more processors 1520 to execute instructions to perform all or part of the steps in the abovementioned method. Moreover, the processing component 1502 may include one or more modules which facilitate interaction between the processing component 1502 and the other components. For instance, the processing component 1502 may include a multimedia module to facilitate interaction between the multimedia component 1508 and the processing component 1502.

The memory 1504 is configured to store various types of data to support the operation of the electronic device. Examples of such data include instructions for any application programs or methods operated on the electronic device, contact data, phonebook data, messages, pictures, video, etc. The memory 1504 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 1506 provides power for various components of the electronic device. The power component 1506 may include a power management system, one or more power supplies, and other components associated with generation, management and distribution of power for the electronic device.

The multimedia component 1508 may include a screen providing an output interface between the electronic device and a user. In some embodiments, the screen may include a Liquid Crystal Display (LCD) and a Touch Panel (TP). If the screen may include the TP, the screen may be implemented as a touch screen to receive an input signal from the user. The TP may include one or more touch sensors to sense touches, swipes and gestures on the TP. The touch sensors may not only sense a boundary of a touch or swipe action but also detect a duration and pressure associated with the touch or swipe action. In some embodiments, the multimedia component 1508 may include a front camera and/or a rear camera. The front camera and/or the rear camera may receive external multimedia data when the electronic device is in an operation mode, such as a photographing mode or a video mode. Each of the front camera and the rear camera may be a fixed optical lens system or have focusing and optical zooming capabilities.

The audio component 1510 is configured to output and/or input an audio signal. For example, the audio component 1510 may include a Microphone (MIC), and the MIC is configured to receive an external audio signal when the electronic device is in the operation mode, such as a call mode, a recording mode and a voice recognition mode. The received audio signal may further be stored in the memory 1504 or sent through the communication component 1516. In some embodiments, the audio component 1510 further may include a speaker configured to output the audio signal.

The I/O interface 1512 provides an interface between the processing component 1502 and a peripheral interface module, and the peripheral interface module may be a keyboard, a click wheel, a button and the like. The button may include, but not limited to: a home button, a volume button, a starting button and a locking button.

The sensor component 1514 may include one or more sensors configured to provide status assessment in various aspects for the electronic device. For instance, the sensor component 1514 may detect an on/off status of the electronic device and relative positioning of components, such as a display and small keyboard of the electronic device, and the sensor component 1514 may further detect a change in a position of the electronic device or a component of the electronic device, presence or absence of contact between the user and the electronic device, orientation or acceleration/deceleration of the electronic device and a change in temperature of the electronic device. The sensor component 1514 may include a proximity sensor configured to detect presence of an object nearby without any physical contact. The sensor component 1514 may also include a light sensor, such as a Complementary Metal Oxide Semiconductor (CMOS) or Charge Coupled Device (CCD) image sensor, configured for use in an imaging application. In some embodiments, the sensor component 1514 may also include an acceleration sensor, a gyroscope sensor, a magnetic sensor, a pressure sensor or a temperature sensor.

The communication component 1516 is configured to facilitate wired or wireless communication between the electronic device and other equipment. The electronic device may access a communication-standard-based wireless network, such as a WIFI network, a 2nd-Generation (2G) or 3G network or a combination thereof. In an exemplary embodiment, the communication component 1516 receives a broadcast signal or broadcast associated information from an external broadcast management system through a broadcast channel. In an exemplary embodiment, the communication component 1516 further may include a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BT technology and another technology.

In an exemplary embodiment, the electronic device 1500 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 1504 including an instruction, and the instruction may be executed by the processor 1520 of the electronic device 1500 to implement the abovementioned method. For example, the non-transitory computer-readable storage medium may be a ROM, a Random Access Memory (RAM), a Compact Disc Read-Only Memory (CD-ROM), a magnetic tape, a floppy disc, an optical data storage device and the like.

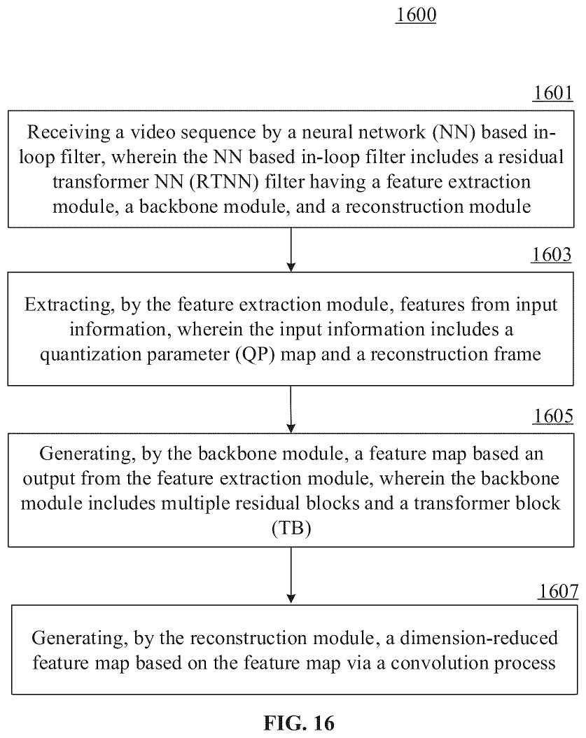

FIG. 16 is a flowchart of a method in accordance with one or more implementations of the present disclosure. The method 1600 can be implemented by a system or an apparatus (such as a system or an apparatus having the RTNN filter discussed herein). The method 1600 is for enhancing image qualities. The method 1600 includes, at block 1601, receiving a video sequence by a neural network (NN) based in-loop filter, wherein the NN based in-loop filter includes a residual transformer NN (RTNN) filter having a feature extraction module, a backbone module, and a reconstruction module.

At block 1603, the method 1600 continues by extracting, by the feature extraction module, features from input information, wherein the input information includes a quantization parameter (QP) map and a reconstruction frame.

At block 1605, the method 1600 continues by generating, by the backbone module, a feature map based an output from the feature extraction module, wherein the backbone module includes multiple residual blocks and a transformer block (TB).

At block 1607, the method 1600 continues by generating, by the reconstruction module, a dimension-reduced feature map based on the feature map via a convolution process.

In some embodiments, the reconstruction frame is a luma reconstruction frame, and the input information further includes a chroma reconstruction frame. In some embodiments, input information further includes a partition frame and a prediction frame.

In some embodiments, the feature extraction module includes multiple convolution layers, a concatenate layer, multiple parametric rectified linear unit (PReLU) layers. In some embodiments, the backbone module includes multiple residual blocks and a transformer block (TB).

In some embodiments, the method 1600 further comprises extracting shallow features from the input information by the multiple residual blocks. In some embodiments, the method 1600 further comprises capturing a long-range correlation between the extracted features by the transformer block.

In some embodiments, the NN based in-loop filter further includes a deblocking filter (DBF), a sample adaptive offset (SAO) filter, and an adaptive loop filter (ALF). The RTNN filter can be positioned between the SAO filter and the ALF

In some examples, the backbone module is for a luma model, and wherein the backbone module includes three residual block groups (RBGs) and six transformer blocks (TBs). Each of the RBGs can include four residual blocks. In other embodiments, the backbone module can have different numbers of RBGs, TBs, and residual blocks.

In some implementations, the backbone module can be for a chroma model, and the backbone module includes three residual attention blocks (RABs) and six transformer blocks (TBs). Each of the RABs can include four residual blocks and an attention block. In other embodiments, the backbone module can have different numbers of RABs, TBs, and residual blocks.

In some embodiments, the attention block includes a special attention block. In some embodiments, the method 1600 further comprises receiving a max-pooling map and an average-pooling map by the special attention block.

In some embodiments, the attention block includes a channel attention block. The channel attention block can include an intensity channel attention module and a contrast channel attention module. Embodiments of the intensity channel attention module is discussed in detail with reference to FIG. 9A. Embodiments of the contrast channel attention module is discussed in detail with reference to FIG. 9B.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### Additional Considerations

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

1. A method for video encoding, comprising:
receiving a video sequence by a neural network (NN) based in-loop filter, wherein the NN based in-loop filter includes a residual transformer NN (RTNN) filter having a feature extraction module, a backbone module, and a reconstruction module;
extracting, by the feature extraction module, features from input information, wherein the input information includes a quantization parameter (QP) map and a reconstruction picture;
generating, by the backbone module, a feature map based an output from the feature extraction module; and
generating, by the reconstruction module, a dimension-reduced feature map based on the feature map via a convolution process.

2. The method of claim 1, wherein the reconstruction picture is a luma reconstruction picture, and wherein the input information further includes a chroma reconstruction picture.

3. The method of claim 1, wherein the input information further includes a partition picture.

4. The method of claim 1, wherein the input information further includes a prediction picture.

5. The method of claim 1, wherein the feature extraction module includes multiple convolution layers, a concatenate layer, multiple parametric rectified linear unit (PReLU) layers.

6. The method of claim 1, wherein the backbone module includes multiple residual blocks and a transformer block (TB).

7. The method of claim 6, further comprising extracting shallow features from the input information by the multiple residual blocks.

8. The method of claim 6, further comprising capturing a long-range correlation between the extracted features by the transformer block.

9. The method of claim 1, wherein the NN based in-loop filter further includes a deblocking filter (DBF), a sample adaptive offset (SAO) filter, and an adaptive loop filter (ALF).

10. The method of claim 9, wherein the RTNN filter is positioned between the SAO filter and the ALF.

11. The method of claim 1, wherein the backbone module is for a luma model, and wherein the backbone module includes three residual block groups (RBGs) and six transformer blocks (TBs).

12. The method of claim 11, wherein each of the RBGs includes four residual blocks.

13. The method of claim 1, wherein the backbone module is for a chroma model, and wherein the backbone module includes three residual attention blocks (RABs) and six transformer blocks (TBs).

14. The method of claim 13, wherein each of the RABs includes four residual blocks and an attention block.

15. The method of claim 14, wherein the attention block includes a special attention block.

16. The method of claim 15, further comprising receiving a max-pooling map and an average-pooling map by the special attention block.

17. The method of claim 14, wherein the attention block includes a channel attention block.

18. A method for video decoding, comprising:
receiving a video sequence by a neural network (NN) based in-loop filter, wherein the NN based in-loop filter includes a residual transformer NN (RTNN) filter having a feature extraction module, a backbone module, and a reconstruction module;
extracting, by the feature extraction module, features from input information, wherein the input information includes a quantization parameter (QP) map and a reconstruction picture;
generating, by the backbone module, a feature map based an output from the feature extraction module; and
generating, by the reconstruction module, a dimension-reduced feature map based on the feature map via a convolution process.

19. A system for video decoding, comprising:
a processor; and
a memory configured to store instructions, when executed by the processor, to:
receive a video sequence by a neural network (NN) based in-loop filter, wherein the NN based in-loop filter includes a residual transformer NN (RTNN) filter having a feature extraction module, a backbone module, and a reconstruction module;
extract, by the feature extraction module, features from input information, wherein the input information includes a quantization parameter (QP) map, a reconstruction picture, a prediction picture, and a partition picture;
generate, by the backbone module, a feature map based an output from the feature extraction module, wherein the backbone module includes multiple residual blocks and a transformer block (TB); and
generate, by the reconstruction module, a dimension-reduced feature map based on the feature map via a convolution process.

20. A non-transitory computer-readable storage medium having stored thereon a computer instruction and a bitstream, wherein the computer instruction, when executed by a processor, enables the processor to perform the steps of the method for video encoding of claim 1 to generate the bitstream.
